(19) United States
(12) Patent Application Publication
(10) Pub. No.: US 2009/0143177 A1
(43) Pub. Date: Jun. 4, 2009

(54) TIMING CHAIN DRIVE UNIT

(75) Inventors: Yoshikazu Nakano, Osaka (JP); Kouhei Kunimatsu, Osaka (JP); Hiroshi Hashimoto, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/270,134

(22) Filed: Nov. 13, 2008

(30) Foreign Application Priority Data
Nov. 30, 2007 (JP) 2007-309909

(51) Int. Cl. F16H 7/08

(52) U.S. Cl. 474/109

(57) ABSTRACT

In an engine timing chain drive, a pivoted chain guide is provided on the tension side of the chain, and a synchronizing sprocket is incorporated into the chain guide and driven by the chain. The synchronizing sprocket rotates a cam which effects reciprocating movement of the guide to compensate for cyclic variations in tension resulting from operation of intake and exhaust valves.

### CROSS-REFERENCE TO RELATED APPLICATION

This application claims priority on the basis of Japanese patent application 2007-309909, filed Nov. 30, 2007. The disclosure of Japanese application 2007-309909 is hereby incorporated by reference.

### FIELD OF THE INVENTION

This invention relates to a timing chain drive unit for transmission of power from the camshaft of an internal combustion engine to one or more camshafts for operating intake and exhaust valves. The invention relates more particularly to improvements in a guide mechanism for controlling tension in a timing chain.

### BACKGROUND OF THE INVENTION

As shown in FIG. 13, a timing chain drive unit 500 in a dual overhead cam (DOHC) internal combustion engine transmits power by means of a chain CH from driving sprocket 550, to driven sprockets 560 and 570. A pivoted slack-side guide, in sliding contact with a part of the chain CH that travels from the driving sprocket 550 a driven sprocket 560, cooperates with a tensioner T, to apply appropriate tension to the chain. A tension-side chain guide 510 is in sliding contact with a portion of the chain that travels from driven sprocket 570 to the driving sprocket to prevent vibration and lateral movement of the chain. Guide 510 controls the length of the span of the chain extending from the point at which the chain disengages the driven sprocket 570 to the point at which the chain engages the driving sprocket 550.

This slack side guide 540 is pivotably mounted on a pivot shaft P, which can be a mounting bolt, a mounting pin, or the like, fixed to, and extending from a wall of the engine E. The tensioner T biases a shoe on the pivoted slack side chain guide 540 against the chain. On the other hand, the tension-side chain guide 510 is immovably fixed to the engine E by mounting bolts Q or other suitable mounting devices.

Further details of the typical timing chain drive unit of the kind described above can be found in Japanese Laid-Open Patent Publication No. 2003-214504.

In the conventional timing chain drive unit, the load torque applied to the camshafts changes cyclically in synchronization with the rotation of the camshafts and the crankshaft. These cyclic changes in load torque in the camshaft result in corresponding cyclic changes in tension in the tension side of the chain CH, that is, the span of the chain traveling from the driven sprocket 570 toward the driving sprocket 550. The cyclic changes in load torque and in chain tension depend on various factors, including the rate of rotation of the crankshaft.

These cyclic changes in load torque and chain tension are generated as a result of forces required to open the intake and exhaust valves. Thus, in the case of an in-line four cylinder engine, a four cycle change in tension occurs for each rotation of a camshaft. In an in-line six cylinder engine, a six cycle change in tension occurs for each rotation of a camshaft.

The chain must have a tensile strength capable of withstanding the peak value of the varying chain tension. Accordingly, conventional timing chains are excessively heavy, the overall weight of the drive unit is high, and excessive noise is generated. Thus, the conventional timing chain drive unit is not suitable for adaptation to demands for size reduction, weight reduction and noise reduction in internal combustion engines.

This invention addresses the above-described problems. An object of the invention is to provide a timing chain drive unit, in which the timing chain can be of smaller and lighter than a conventional timing chain, and in which quieter operation of the timing chain drive unit is achieved. In particular, in the timing chain drive unit of the invention, the influence of changes in tension corresponding to a change in a load torque due to intake and exhaust valve operation is reduced.

### SUMMARY OF THE INVENTION

The timing chain drive unit according to the invention comprises a driving sprocket on a crankshaft of an engine, a driven sprocket on an intake and exhaust valve-operating camshaft of said engine, and a chain connecting the sprockets in driving relationship. The chain has a slack side which travels from the driving sprocket toward the driven sprocket, and a tension side which travels from the driven sprocket toward the driving sprocket. The operation of intake and exhaust valves in the engine causes cyclic increases and decreases in tension in the tension side of the chain. The drive unit also comprises a first chain guide in contact with the slack side of the chain, a tensioner urging the first chain guide against the slack side of the chain, and a second chain guide in contact with the tension side of the chain. The second chain guide is mounted for movement in a tightening direction to tighten the tension side of the chain and in an opposite, loosening, direction to loosen the tension side of the chain. A synchronizing sprocket is rotatably mounted on the second chain guide, and engaged with, and rotatable by, the chain as the chain moves in contact with the second chain guide toward the driving sprocket. A cam engaging element, and a cam driven by the synchronizing sprocket and in contact with said cam-engaging element, alternately move the second chain guide in the tightening and loosening directions. The synchronizing sprocket is rotatable by the chain at a rate such that the movements of the second chain guide in the loosening direction occur at a frequency equal to the frequency of the cyclic increases in tension in the chain.

The cam is preferably an eccentric cylindrical boss formed on the synchronizing sprocket.

The second chain guide is preferably pivoted on a pivot axis, and the synchronizing sprocket is preferably rotatably mounted on the second chain guide for rotation on an axis parallel to, and remote from the pivot axis.

The number of teeth of the synchronizing sprocket can be such that the synchronizing sprocket rotates through one full rotation for every two cycles of increases and decreases in tension in the tension side of the chain. In that case, the cam is preferably an oval-shaped cam having two lobes.

Where the chain is a roller chain, the tooth forms of the synchronizing sprocket are preferably shaped to have a reduced impact with the rollers of the chain compared to the impact of the rollers with a standard sprocket tooth form. Preferably, the synchronizing sprocket is aligned with a part of a surface of the second chain guide engaged by the chain, the sprocket has teeth separated by tooth gaps, and the tooth gaps are sufficiently deep that bottom portions of the tooth gaps are spaced from the rollers of the chain at all times during engagement of the rollers with the synchronizing sprocket.

In one alternative embodiment, the chain includes link plates, and the synchronizing sprocket is in driven engagement with said link plates of the chain.

In another alternative embodiment, the chain has link plates along both sides thereof, sprocket-engaging elements protrude laterally from the link plates, and the synchronizing sprocket is engageable with the laterally protruding sprocket-engaging elements.

At least in the case in which the synchronizing sprocket engages the rollers of a roller chain, or the link plates along on both sides of a chain the synchronizing sprocket is preferably rotatably mounted in a slot formed in the second chain guide.

The phase relationship between the uncompensated cyclically varying tension in the chain and the position of the chain guide as it is reciprocated by operation of the synchronizing sprocket, can be selected for optimum smoothing of the chain tension. Preferably, maximum velocity of the chain guide, when moving in the direction to reduce tension, coincides approximately with peaks in the uncompensated chain tension. Likewise, the maximum velocity of the chain guide, when moving in the direction to increase tension, coincides approximately with minima in the uncompensated chain tension.

The operation of the synchronizing sprocket in conjunction with the tension side chain guide decreases the peak value of the tension in the tension side of the chain, making it possible to utilize a smaller and lighter chain, and at the same time to realize a reduction in noises due to cyclic changes in tension.

The provision of a pivoted guide on the tension side of the chain and the addition of a synchronizing sprocket to the guide is structurally simple, and results in a guide structure comparable in weight to that of a conventional tension side guide. Because the chain tension peaks are avoided, a smaller and lighter chain can be used, and the overall size and weight of the timing chain drive unit can be reduced.

When the cam is in the form of an oval boss having two lobes, the number of teeth on the synchronizing sprocket can be increased and its rate rotation can be reduced by one-half. With this cam configuration, even in the case of a multi-cylinder engine having a relatively large number of intake and exhaust valves, cyclic changes in chain tension is short can be effectively and reliably controlled.

By adopting a special tooth configuration for the synchronizing sprocket, preferably one in which the rollers of a roller chain do not contact the tooth gap bottoms, smoother engagement between the synchronizing sprocket and the chain can be achieved, noises and vibration can be reduced, and the incidence of breakage of the rollers can be reduced.

When the synchronizing sprocket engages the plates of the chain instead of the rollers, wear and breakage of the rollers can be reduced, and noise and vibration due to changes in tension can be reduced without shortening the useful life of the rollers.

When the synchronizing sprocket engages lateral protrusions on the chain, the timing chain can rotate the synchronizing sprocket without any contact between the sprocket and the rollers or link plates of the chain. Thus, the incidence of wear and breakage of the rollers and link plates can be reduced, and noise and vibration due to changes in tension can be reduced without shortening the useful life of the chain.

### BRIEF DESCRIPTION OF THE DRAWINGS

FIG. 1 is a schematic front elevational view of a timing chain drive unit according to the invention;

FIG. 2 is an exploded perspective view of the tension side chain guide the invention;

FIG. 3 is an enlarged transparent view of a part of the tension side chain guide shown in FIG. 2;

FIG. 4 is a cross-sectional side view of a part of the tension side chain guide shown in FIG. 2;

FIG. 5 is a schematic view showing four successive stages in the pivoting of a synchronizing sprocket according to the invention;

FIG. 6 is a side elevational view of another embodiment of a synchronizing sprocket according to the invention;

FIG. 7 is schematic view showing the form of a tooth gap bottom in a synchronizing sprocket according to the invention;

FIG. 8 is schematic view showing the form of a tooth head in a synchronizing sprocket according to the invention;

FIG. 9 is a schematic view showing an asymmetric tooth form in a synchronizing sprocket according to the invention;

FIG. 10 is a schematic view showing a synchronizing sprocket according to the invention engaging a link plate;

FIG. 11 is a schematic view showing a synchronizing sprocket according to the invention engaging an explanatory view in which a synchronizing sprocket of the invention engaging a protruding element on a chain;

FIG. 12 is graphical plot illustrating the relationship between the cyclic changes in tension in a chain, and the pivoting cycle of a synchronizing sprocket according to the invention; and

FIG. 13 is a schematic front elevational view of a conventional timing chain drive unit.

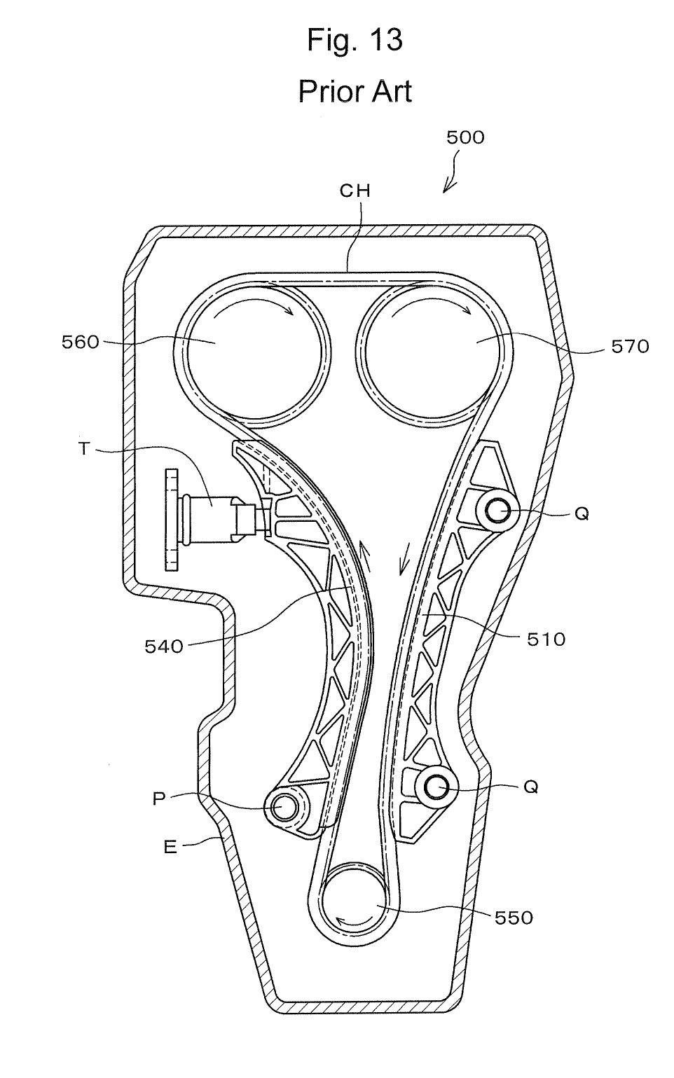

### DETAILED DESCRIPTION OF THE PREFERRED EMBODIMENTS

In accordance with the invention, the tension side of an engine timing chain is arranged to drive a synchronizing sprocket which, in turn, causes a movable chain guide in contact with the tension side of the chain to move in tightening and loosening directions synchronously with the cyclic increase and decrease in tension due to the operation of the engine's intake and exhaust valves. These movements of the chain guide reduce the influence of changes in tension in the chain, and make it possible to use a chain that is smaller in size and lighter in weight than a conventional timing chain having the same loading capability. The use of the synchronizing sprocket improves the quietness of timing drive. The advantages of the invention can be realized in various embodiments, as described below.

The timing drive according to the invention will ordinarily include a movable guide in sliding engagement with the slack side of the chain and cooperating with a hydraulic tensioner or other suitable tension-controlling device.

The chain guides on the tension side and on the slack side preferably have chain-engaging surfaces preferably composed of high strength, light-weight materials exhibiting low frictional resistance to the chain. For example, the guides can be composed entirely of resins such as polytetrafluoroethylene (TEFLON) or the like, or composed of a base made of aluminum alloy or other suitable metal, with a low friction resin shoe fixed to the base and positioned for sliding contact with the chain.

The synchronizing sprocket, which is mounted on the guide that is in sliding contact with the tension side of the chain, is provided with a cam that cooperates with a cam-engaging element to effect reciprocating motion of the guide. The cam-engaging element can be a fixed element in sliding contact with the cam. Preferably, however, the cam-engaging element is a roller which rotates about a shaft fixed to the engine block.

The synchronizing sprocket of the invention is preferably designed with special tooth forms in order to reduce impact with the chain rollers. For example, the tooth form of the sprocket can be such that the tooth gap bottoms are deeper than those of a conventional or standard sprocket. Alternatively, the tooth heads can be lower than standard sprocket tooth heads, or asymmetric sprocket tooth forms can be adopted. In addition, combinations of these tooth form variations can be utilized.

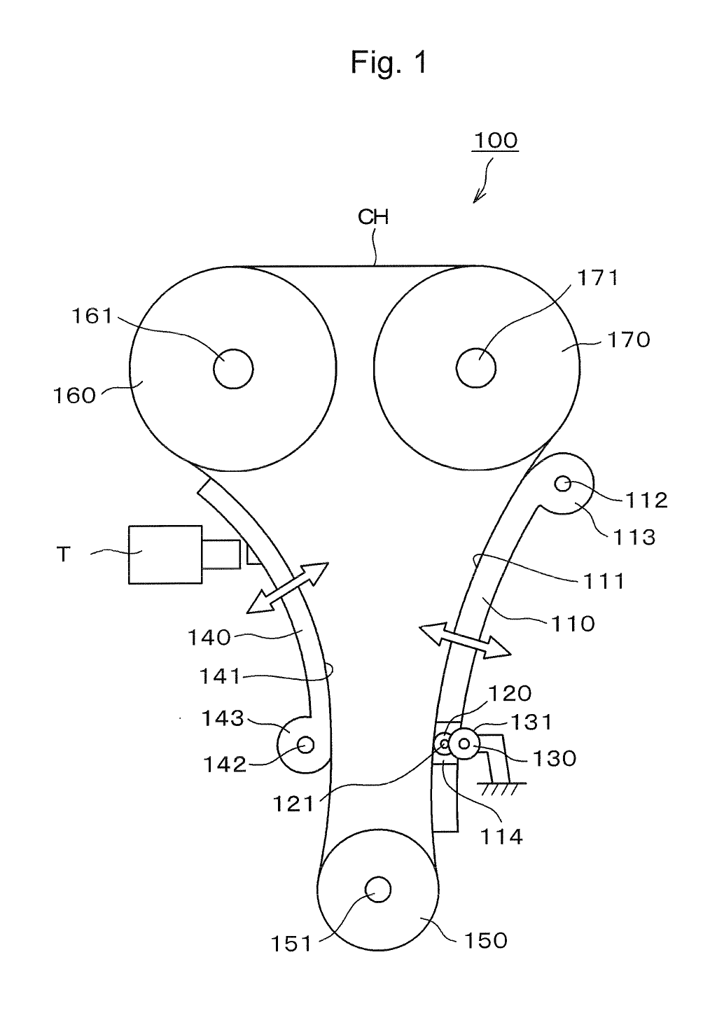

In the chain drive unit 100 shown in FIG. 1, an endless chain CH is engaged with a driving sprocket 150 on the crankshaft 151 of an engine, and with driven sprockets 160 and 170, on camshafts 161 and 171 respectively. The chain transmits power from the engine crankshaft to the camshafts, which are arranged to operate intake and exhaust valves.

A tensioner T cooperates with a pivoted slack side chain guide 140, which is in sliding engagement with a part of the chain that travels from the crankshaft sprocket 150 toward camshaft sprocket 160. The slack side chain guide 140 includes a shoe surface 141, which is in sliding contact with chain CH, and both limits the path of travel of the chain and maintains appropriate tension in the chain. The chain guide 140 is supported by, and pivoted on, a shaft 142, which can be a bolt, a mounting pin or the like. The shaft 142 extends into a hole in boss 143 formed at one end of the guide at a location remote from the portion of the guide contacted by the plunger of tensioner T.

A tension side chain guide 110 is in sliding engagement with the tension side of the chain, that is, the portion of the chain that travels from camshaft sprocket 170 toward crankshaft sprocket 150. The torque of the crankshaft 151 applies tension to this side of the chain, and the tension exerts a force on the guide 110, causing it to pivot about a fixed shaft 112 in a direction substantially perpendicular to the direction of travel of the portion of the chain traveling from sprocket 170 toward sprocket 150. This tension side chain guide 110 includes a chain-contacting shoe surface 111, which is in sliding contact with the chain. The guide 110 limits the path of travel of, and controls tension in, the tension side of the chain. Shaft 112, which can be a bolt, a pin, or the like, extends into a hole in a pivoting boss 113 formed at one end of the guide.

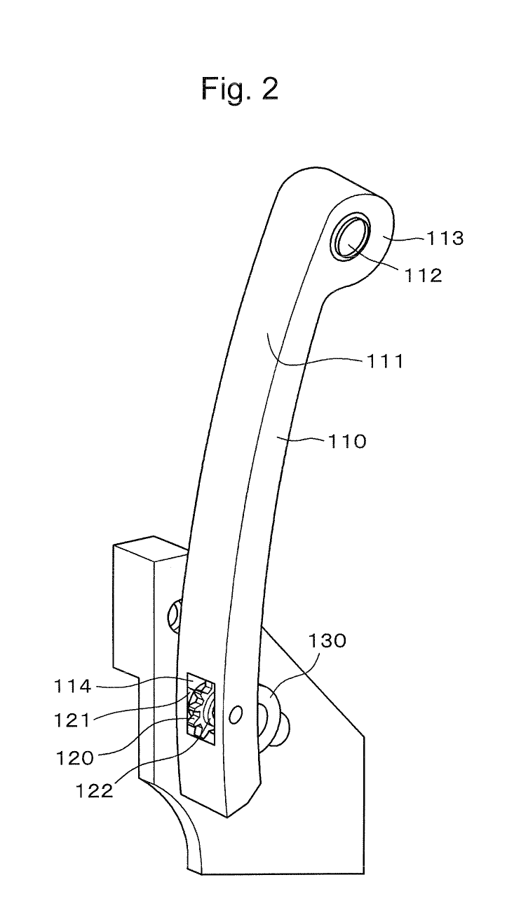

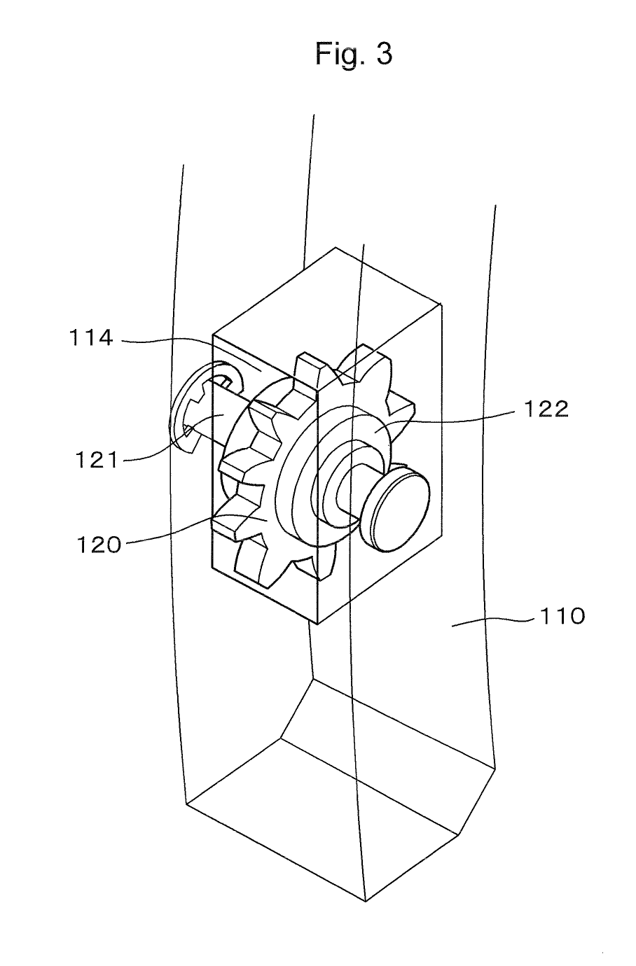

As shown in FIGS. 2 and 3, a synchronizing sprocket 120 is rotatably mounted in a slot 114 formed in the guide body at a location remote from pivoting boss 113. The teeth of the synchronizing sprocket protrude from slot 114 and are aligned with shoe surface 111 so that they can mesh with a chain traveling along the guide. When the synchronizing sprocket 120 is rotated by the chain, a cam 122 on the sprocket cooperates with a cam-engaging element to effect pivoting motion of the guide 110 so that its chain-contacting shoe surface 111 moves reciprocably in directions substantially perpendicular to the direction of travel of the chain over the guide.

As shown in FIGS. 1 to 3, the synchronizing sprocket 120 is rotatable about a shaft 121, which is held in the guide 110 and extends across slot 114. The synchronizing sprocket 120 has a cylindrical boss 122, which is off-centered with respect to the axis of rotation of the sprocket on shaft 121. The boss 122, therefore, acts as a cam to effect reciprocating motion of the guide 110 about its pivot shaft 112. The surface with which the cam cooperates is preferably the circular, cylindrical peripheral surface 131 of a roller 130, which is rotatable about a fixed axis parallel to the axis of rotation of the synchronizing sprocket 120 and its boss 122. Because the roller 130 is rotatable, the boss 122 is in rolling contact with the roller, and friction is reduced.

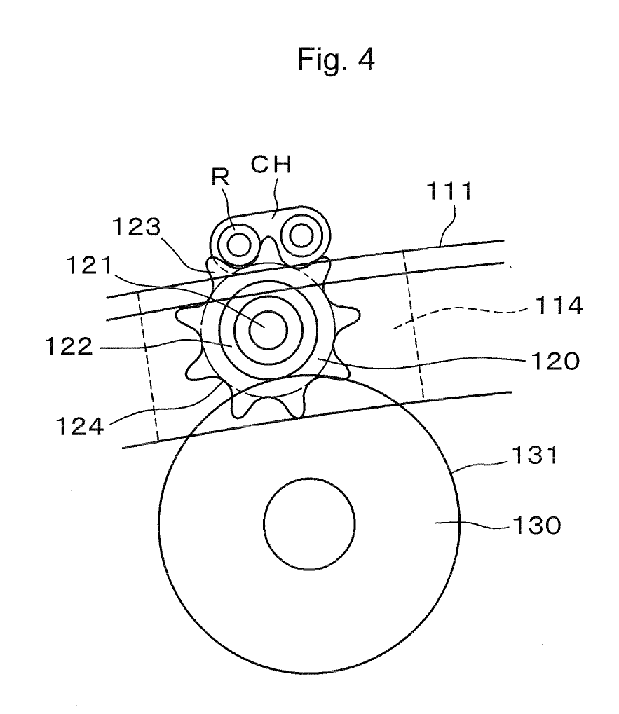

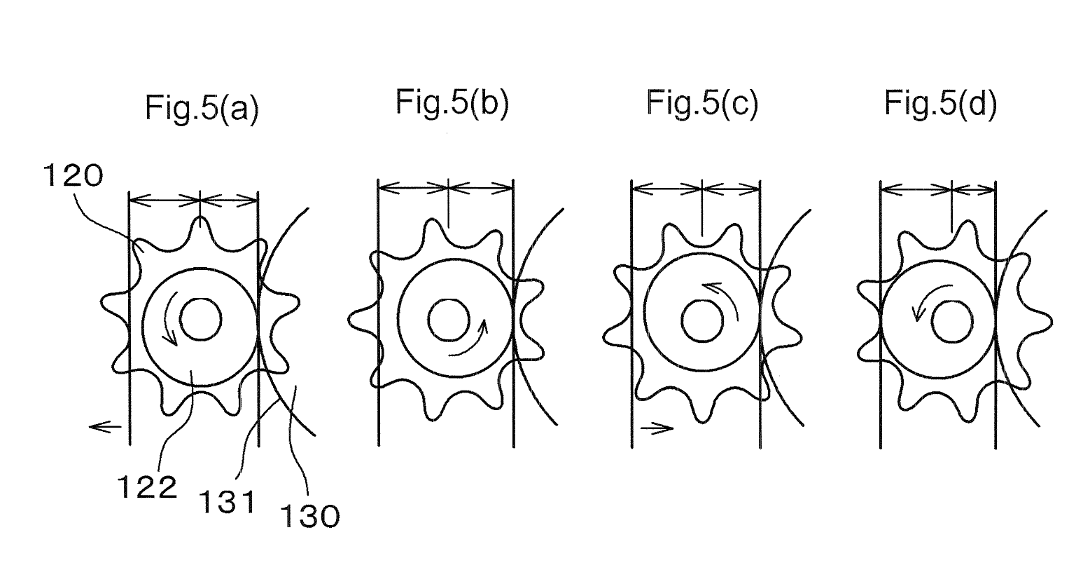

As shown in FIGS. 4 and 5, teeth 123 of the synchronizing sprocket 120 protrude past the shoe surface 111 of the tension side chain guide 110. The chain CH, which travels along the shoe surface, meshes with the protruding teeth of the sprocket 120, causing the sprocket to rotate. The tooth forms of sprocket teeth 123 are preferably designed so that the tooth gap bottoms 124 do not abut the rollers R of the chain. Because the tooth gap bottoms do not abut the rollers, the chain CH can slide smoothly on the shoe surface 111 of the guide 110, without being repeatedly lifted away from the shoe surface as the sprocket rotates. Avoidance of abutting contact of the rollers with the tooth gap bottoms 124 also reduces wear and breakage of the rollers of the chain.

And as shown in FIGS. 5(a) to 5(d), the cylindrical boss 122, which is eccentric relative to the synchronizing sprocket 120, rotates with the synchronizing sprocket while in rolling contact with surface 131 of the roller 130. Because the boss 122 is eccentric with respect to the axis of rotation of the synchronizing sprocket, a reciprocating motion is imparted to the guide, and the distance between its shoe surface 111 and the roller surface 131 varies cyclically through distance equal to twice the eccentricity of the boss 122. As a result, the tension side chain guide 110 pivots in a direction substantially perpendicular to the direction of travel of the portion of the chain CH that is in sliding contact with shoe surface 111.

The number of teeth of the synchronizing sprocket 120 is selected so that the rotation of the synchronizing sprocket and its boss 122 is synchronized with cyclic variations of tension in the tension side of the chain resulting from variations in torque in the camshaft 171 (FIG. 1) due to the varying load imparted to the camshaft by the of intake and exhaust valves which it operates. The operation of the synchronizing sprocket, its boss 122 and the cooperating roller 130, causes the tension side guide 110 to pivot reciprocably, and thereby compensate for these cyclic variations in chain tension.

The eccentricity of the boss 122, and the phase relationship between the motion of the guide and the tension variations in the chain due to valve operation, should be selected according to the pattern of changes in chain tension, the traveling speed of the chain, the rigidity and length of the chain, and the mounting position of the synchronizing sprocket 120 in order to achieve optimum absorption of the cyclic changes in chain tension.

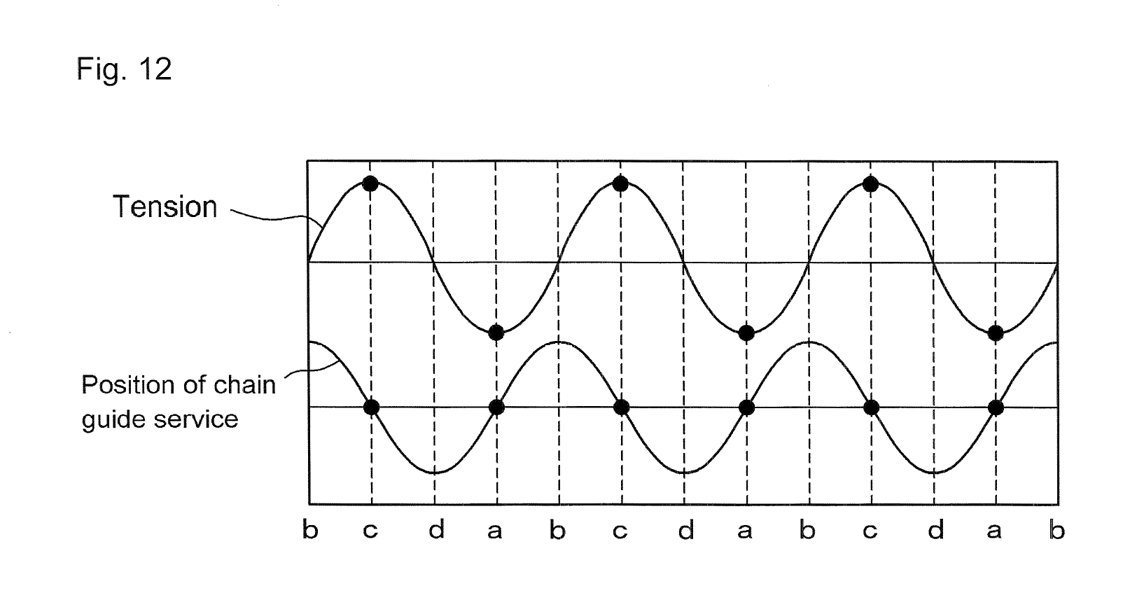

The cyclic changes in tension and the pivoting motion of the chain guide 110 both approximate sine curves. The initial rotational position of the synchronizing sprocket, as it first comes into mesh with the chain during assembly of the timing drive, is preferably such so that the phase relationship between these curves is approximately as shown in FIG. 12. As shown in FIG. 12, the rate at which the chain guide advances in the tightening direction against the chain (i.e., the slope of the chain position curve) is a maximum approximately at the times the tension in the chain reaches a minimum. The maximum rate of advance of the guide and the minimum chain tension occur at times a in FIG. 12. Likewise, the rate at which the chain guide retracts in the loosening direction reaches a maximum approximately at the times the chain tension reaches a maximum. The maximum rate of retraction of the guide and the maximum chain tension occur at times c. When the phase of the chain guide position leads the phase of the tension in the chain by approximately 90 E, as shown in FIG. 12, changes in tension can be effectively absorbed.

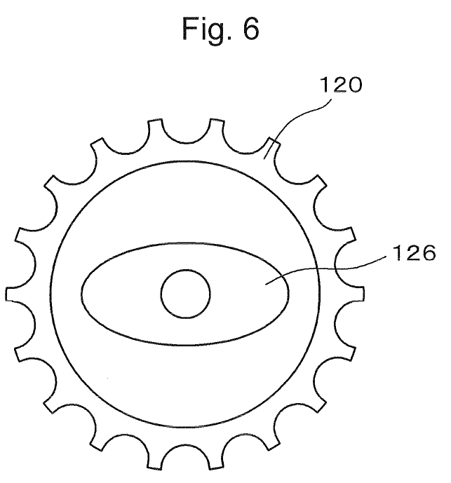

When the cycle of changes in chain tension is short, as in the case of a six cylinder engine for example, the number of teeth on the synchronizing sprocket 120 can be reduced to achieve higher speed rotation so that the pivoting cycle of the chain guide 110 is correspondingly short. However, an alternative solution, as shown in FIG. 6 is to providing an oval-shaped boss 126, which can be coaxial with the synchronizing sprocket 120. This oval boss serves essentially as a two-lobed cam which, in cooperation with the roller 130, or with another suitable contacting surface, causes the guide to pivot through two cycles as the synchronizing sprocket 120 goes through one rotation. Thus, the number of teeth on the synchronizing sprocket does not need to be reduced, and its speed of rotation does not need to be increased.

Although the circular boss 122 or the oval boss 126 will suffice for most applications, it is possible to utilize cams having other configurations, such as cams having asymmetric shapes, or cams having three or more lobes so that the guide goes through three or more cycles of reciprocation for each rotation of the synchronizing sprocket.

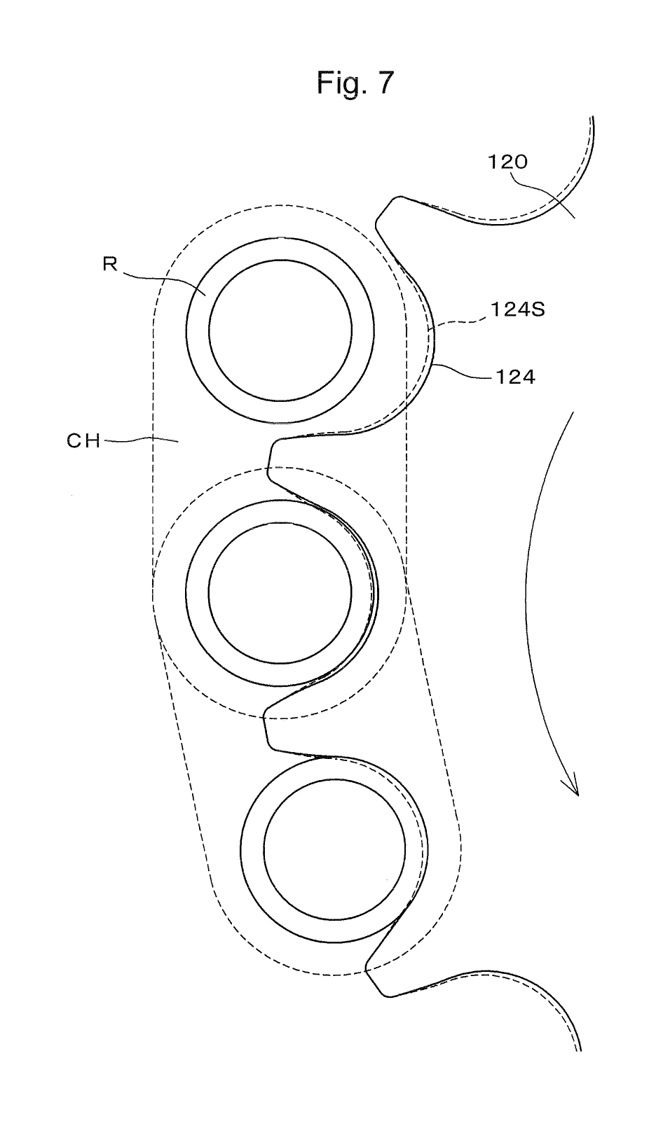

As shown in FIG. 7, the synchronizing sprocket 120 can have a tooth form such that its tooth gap bottoms 124 are more deeply contoured than the tooth gap bottoms 124S of a standard tooth form, as shown by a broken line. That is, the sprocket can be formed with so called “minus” tooth gap bottoms. This sprocket tooth form reduces noise and vibration because the chain rollers R do not come into contact with the tooth gap bottoms 124. The chain can slide smoothly on the shoe surface of the guide because it is not lifted away form the guide by contact between its rollers and the tooth gap bottoms of the sprocket. In addition, this configuration also reduces wear and breakage of the chain rollers.

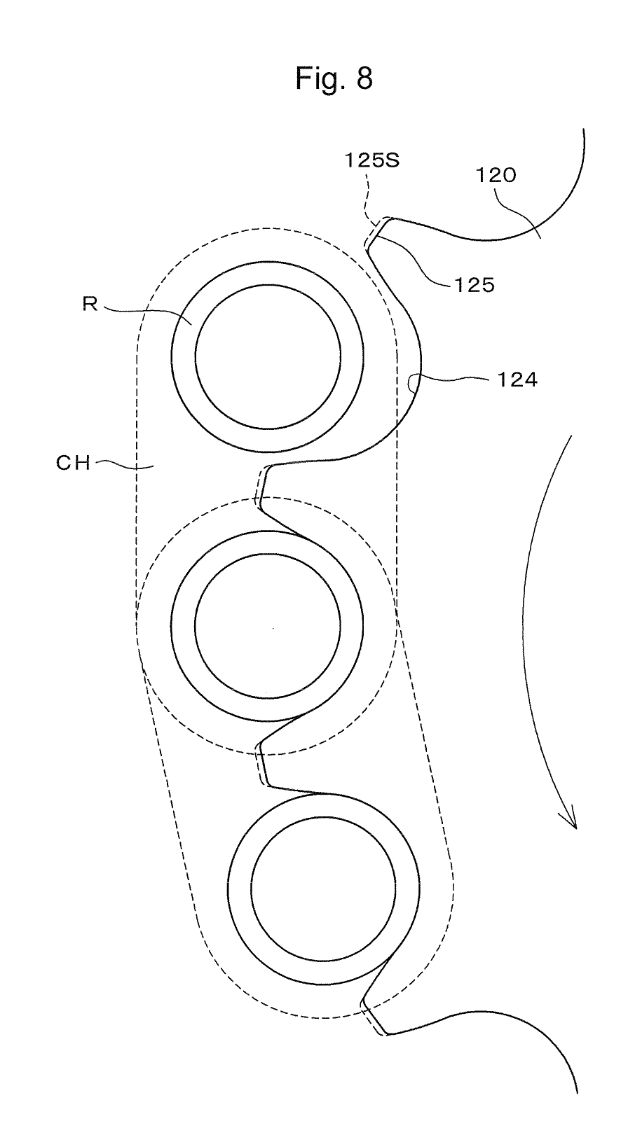

In another tooth form, as shown in FIG. 8, the tooth heads 125 of the synchronizing sprocket 120 are lower than the tooth heads 125S of a standard tooth form, shown by broken lines. That is the sprocket can be formed with so-called “minus diameter” tooth heads. This shape reduces noise and vibration by reducing the maximum distance by which the synchronizing sprocket teeth protrude beyond the chain-contacting shoe surface of the chain guide. With this configuration, the chain rollers R can smoothly engage with and disengages from the synchronizing sprocket, and, at the same time, wear and breakage of the chain rollers can be reduced.

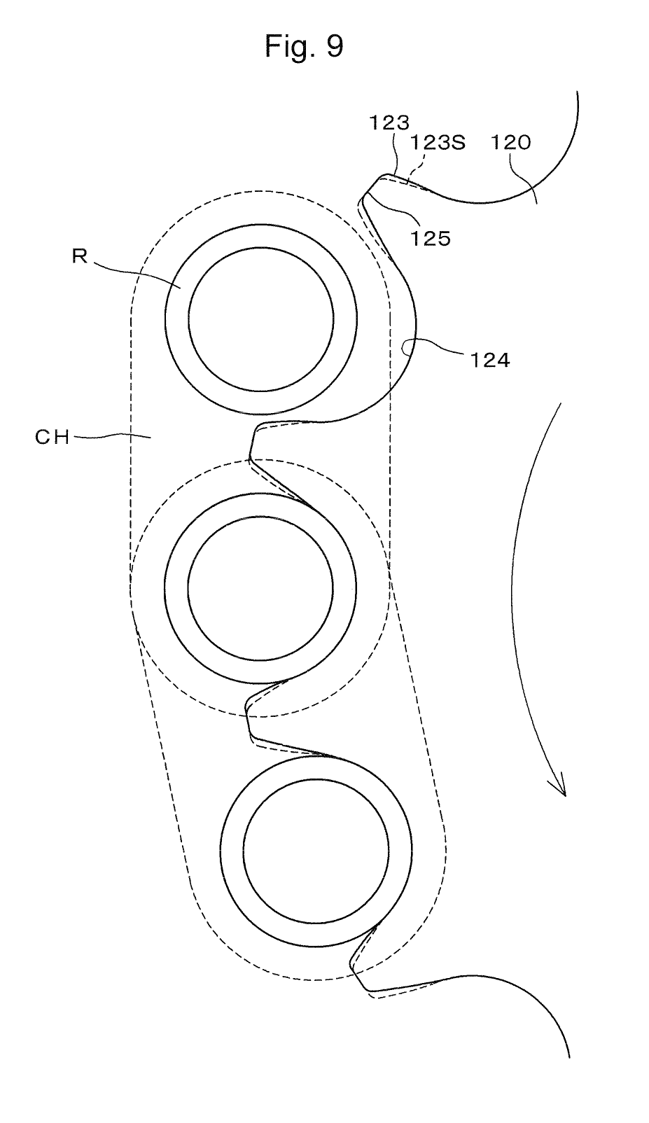

In still another tooth form, as shown in FIG. 9, the curves extending from the tooth gap bottoms 124 to the tooth heads 125 are asymmetric, being different on the front and rear sides of the tooth 123. By way of contrast, the standard tooth portion 123S, which is symmetrical, is shown by a broken line. This asymmetric tooth shape also reduces noise and vibration by enhancing smooth engagement and disengagement of chain rollers R, and at the same time reduces wear and breakage of the rollers.

In the timing chain drive unit of the invention, since force due to the tension in the chain CH is applied to the shoe surface of the tension side chain guide, the synchronizing sprocket 120 does not absorb chain tension and is merely driven by the chain without affecting the path of travel of the chain. Therefore, a high degree of flexibility is afforded in the choice of the above-mentioned special tooth forms. Moreover, various combinations of the above-mentioned tooth shapes, and other tooth shapes, can be adopted in order to minimize impact, reduce noise and vibration and minimize wear and breakage.

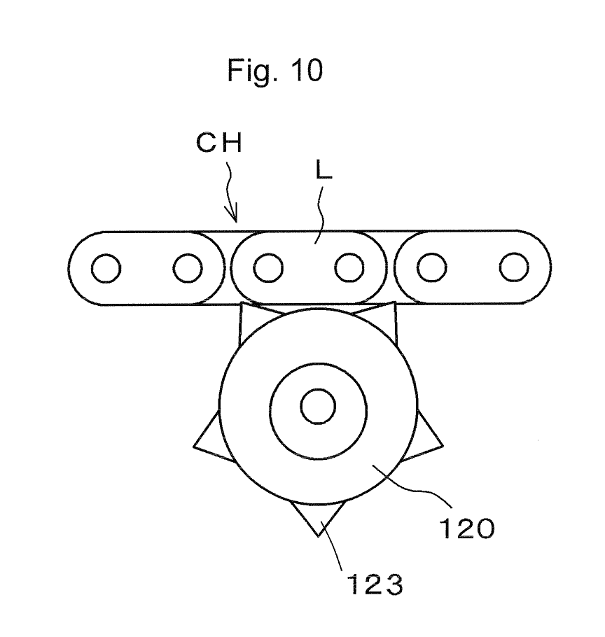

In order to realize advantages of the invention, it is not essential that the synchronizing sprocket mesh with rollers of the timing chain. For example, as shown in FIG. 10, the synchronizing sprocket 120 can have teeth 123 which engage the link plates L of the chain CH so that the sprocket is driven by the link plates rather than by the chain rollers. In this case, there is no contact at all between the synchronizing sprocket and the chain rollers, and consequently, there is neither a reduction in the useful the life of the rollers R, nor a possibility of wear or breakage of the chain rollers, resulting from contact with the synchronizing sprocket.

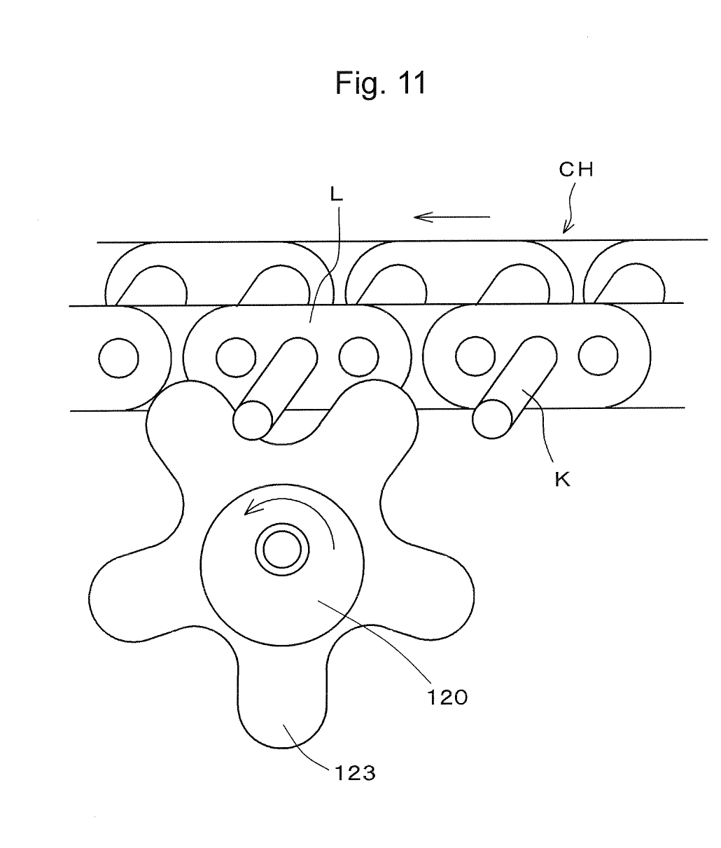

Another example of a case in which the chain rollers do not engage the synchronizing sprocket is shown in FIG. 11. In this example, the synchronizing sprocket engages protrusions K, which extending laterally from link plates L on one side of the chain CH. Here as in the example of FIG. 10, there is no contact between the synchronizing sprocket and the chain rollers, and consequently, there is neither a reduction in the useful the life of the rollers R, nor a possibility of wear or breakage of the chain rollers, resulting from contact with the synchronizing sprocket. Moreover, the use of lateral protrusions K affords a high degree of flexibility in the choice of the shapes of the sprocket teeth 123 and of the protrusions, for optimum reduction in noise and vibration.

We claim:

1. A timing chain drive unit comprising a driving sprocket on a crankshaft of an engine, a driven sprocket on an intake and exhaust valve-operating camshaft of said engine, and a chain connecting said sprockets in driving relationship, the chain of the drive unit having a slack side which travels from the driving sprocket toward the driven sprocket, and a tension side which travels from the driven sprocket toward the driving sprocket, wherein the operation of intake and exhaust valves in said engine causes cyclic increases and decreases in tension in said tension side of the chain, said timing chain drive unit also comprising a first chain guide in contact with said slack side and a tensioner urging said first chain guide against said slack side of the chain, a second chain guide in contact with said tension side of the chain, said second chain guide being mounted for movement in a tightening direction to tighten said tension side of the chain and in an opposite, loosening, direction to loosen said tension side of the chain, and a synchronizing sprocket rotatably mounted on said second chain guide, the synchronizing sprocket being engaged with and rotatable by said chain as the chain moves in contact with said second chain guide toward the driving sprocket, a cam engaging element, and a cam, driven by the synchronizing sprocket and in contact with said cam-engaging element, for alternately moving the second chain guide in said tightening and loosening directions, the synchronizing sprocket being rotatable by said chain at a rate such that the movements of the second chain guide in the loosening direction occur at a frequency equal to the frequency of the cyclic increases in tension in the chain.

2. A timing chain drive unit according to claim 1, in which said cam is an eccentric cylindrical boss formed on said synchronizing sprocket.

3. A timing chain drive unit according to claim 1, in which said second chain guide is pivoted on a pivot axis, and in which said synchronizing sprocket is rotatably mounted on the second chain guide for rotation on an axis parallel to, and remote from said pivot axis.

4. A timing chain drive unit according to claim 1, in which the number of teeth of said synchronizing sprocket is such that the synchronizing sprocket rotates through one full rotation for every two cycles of said increases and decreases in tension, and in which said cam is an oval-shaped cam having two lobes.

5. A timing chain drive unit according to claim 1, in which said chain is a roller chain, and in which the tooth forms of said synchronizing sprocket are shaped to have a reduced impact with said rollers compared to the impact of said rollers with a standard sprocket tooth form.

6. A timing chain drive unit according to claim 1, in which said chain is a roller chain, in which the synchronizing sprocket is aligned with a part of a surface of said second chain guide engaged by said chain, and in which the sprocket has teeth separated by tooth gaps, and in which the tooth gaps are sufficiently deep that bottom portions of the tooth gaps are spaced from the rollers of the chain at all times during engagement of said rollers with the synchronizing sprocket.

7. A timing chain drive unit according to claim 2, in which said chain is a roller chain, in which the synchronizing sprocket is aligned with a part of a surface of said second chain guide engaged by said chain, and in which the sprocket has teeth separated by tooth gaps, and in which the tooth gaps are sufficiently deep that bottom portions of the tooth gaps are spaced from the rollers of the chain at all times during engagement of said rollers with the synchronizing sprocket.

8. A timing chain drive unit according to claim 3, in which said chain is a roller chain, in which the synchronizing sprocket is aligned with a part of a surface of said second chain guide engaged by said chain, and in which the sprocket has teeth separated by tooth gaps, and in which the tooth gaps are sufficiently deep that bottom portions of the tooth gaps are spaced from the rollers of the chain at all times during engagement of said rollers with the synchronizing sprocket.

9. A timing chain drive unit according to claim 4, in which said chain is a roller chain, in which the synchronizing sprocket is aligned with a part of a surface of said second chain guide engaged by said chain, and in which the sprocket has teeth separated by tooth gaps, and in which the tooth gaps are sufficiently deep that bottom portions of the tooth gaps are spaced from the rollers of the chain at all times during engagement of said rollers with the synchronizing sprocket.

10. A timing chain drive unit according to claim 1, in which said chain includes link plates, and in which said synchronizing sprocket is in driven engagement with said link plates of the chain.

11. A timing chain drive unit according to claim 2, in which said chain includes link plates, and in which said synchronizing sprocket is in driven engagement with said link plates of the chain.

12. A timing chain drive unit according to claim 3, in which said chain includes link plates, and in which said synchronizing sprocket is in driven engagement with said link plates of the chain.

13. A timing chain drive unit according to claim 4, in which said chain includes link plates, and in which said synchronizing sprocket is in driven engagement with said link plates of the chain.

14. A timing chain drive unit according to claim 1, in which said chain has link plates along both sides thereof, and sprocket-engaging elements protruding laterally from said link plates, and in which said synchronizing sprocket is engageable with said sprocket-engaging elements.

15. A timing chain drive unit according to claim 2, in which said chain has link plates along both sides thereof, and sprocket-engaging elements protruding laterally from said link plates, and in which said synchronizing sprocket is engageable with said sprocket-engaging elements.

16. A timing chain drive unit according to claim 3, in which said chain has link plates along both sides thereof, and sprocket-engaging elements protruding laterally from said link plates, and in which said synchronizing sprocket is engageable with said sprocket-engaging elements.

17. A timing chain drive unit according to claim 4, in which said chain has link plates along both sides thereof, and sprocket-engaging elements protruding laterally from said link plates, and in which said synchronizing sprocket is engageable with said sprocket-engaging elements.
